(19) United States
(12) Patent Application Publication
(10) Pub. No.: US 2019/0010903 A1
(43) Pub. Date: Jan. 10, 2019

(54) ACOUSTIC ATTENUATION DEVICE FOR AN INTAKE LINE

(71) Applicant: NOVARES France, Clamart (FR)

(72) Inventors: Thomas Jean, HOUDAIN (FR); Aurelien LORENSKI, FILLIEVRES (FR); François GUILLEMANT, ARRAS (FR); Arnaud PLESSY, BRUAY LA BUISSIERE (FR)

(21) Appl. No.: 15/769,515

(22) PCT Filed: Oct. 13, 2016
(86) PCT No.: PCT/FR2016/052647

§ 371 Date: Sep. 21, 2018

(30) Foreign Application Priority Data
Oct. 19, 2015 (FR) 15/59939

(51) Int. Cl. F02M 35/12; F02M 35/10; G10K 11/162

(52) U.S. Cl. CPC F02M 35/1272; F02M 35/1266; G10K 11/162; F02M 35/10157; F02M 35/10006

(57) ABSTRACT

The invention relates to an acoustic attenuation device (1) for a turbocharger, or for a supercharger, arranged along an air intake line of a vehicle. The attenuation device (1) comprises a gas supply pipe (2) having a peripheral wall (21) and a diameter (d2), the pipe (2) comprising at least one annular chamber (3) defined by a diameter (d3) greater than the diameter (d2) of the pipe (2), the or each annular chamber (3) being sealed by a wall (5) comprising porous material that is positioned in the extension of the peripheral wall (21) of the pipe (2), according to a diameter (d5) substantially equal to the diameter of the pipe (2), in order to allow air to flow between the pipe (2) and the or each peripheral chamber (3).

### CROSS REFERENCE TO RELATED APPLICATIONS

This application is a National Stage of PCT Application No. PCT/FR2016/052647 filed on Oct. 13, 2016, which claims priority to French Patent Application No. 15/59939 filed on Oct. 19, 2015, the contents each of which are incorporated herein by reference thereto.

### TECHNICAL FIELD

The present invention concerns an acoustic attenuation device for an intake line of a thermal combustion engine equipped with one or more turbocompressor(s).

### BACKGROUND

Internal combustion engines have a low frequency acoustic component ranging from 30 Hz to 1 kHz. This component is generated by the opening and the closing of the valves, as well as by the resonance of the different cavities of the engine (combustion chambers, conduits, . . . ).

Furthermore, in the case of supercharged engines by turbocompressor, there is a high frequency acoustic component ranging from 800 Hz to 15 kHz. This acoustic component is generated by the turbocompressor and may be propagated and radiate through the air intake conduits.

The conventional solutions for attenuating noises propagated by the turbocompressor along the air intake conduits, comprise in particular the use of resonators, silencers, quarter-wave devices and expansion chambers.

One of these solutions is, for example, described in the document EP 1 255 071 which has a multi-cavity attenuator. These different acoustic artifices each attenuate the noises on a given spectral band. It is therefore necessary to combine several acoustic artifices to attenuate all emitted noises. Thus, these acoustic artifices might require a large volume while the space available in an engine location of a vehicle is very small. In addition, the accumulation of several acoustic artifices increases the pressure losses in the air intake circuit, which is harmful to the performance of the vehicle and may be prejudicial to the fuel consumption.

Conversely, the use of a conduit devoid of acoustic artifices does not create pressure losses but does not allow any attenuation of the noises propagated by the turbocompressor.

### BRIEF SUMMARY

Consequently, the invention aims at proposing a space-saving noise attenuation device, which allows attenuating the noises propagated in the air intake conduits while minimizing the pressure losses.

According to a general definition, the invention concerns an acoustic device for an intake line of a thermal combustion engine equipped with a turbocompressor. The noise attenuation device comprises a gas conveying conduit having a peripheral wall defined by an inner diameter. The conduit comprises at least one annular chamber defined by a diameter greater than the diameter of the conduit. The, or each, annular chamber is closed by a wall comprising a porous material which is positioned in the extension of the peripheral wall of the conduit, along a diameter substantially equal to the diameter of the conduit, to allow an air circulation between the conduit and the, or each, peripheral chamber, by reducing the pressure losses due to the change of section between the conduit and the, or each, annular chamber.

Thus, the invention proposes a space-saving acoustic attenuation device, which allows attenuating the noises propagated in the air intake conduits while minimizing the pressure losses. The use of a porous material closing the, or each, annular chamber allows attenuating the noises propagated in the conduit without generating significant pressure losses. In other words, the attenuation device according to the invention allows an optimal compromise between acoustic attenuation and pressure losses in an intake line.

According to a particular arrangement, the attenuation device may have a compartment which comprises an outer wall in the extension of the, or each, annular chamber, and an inner wall formed by a portion of the peripheral wall of the conduit, the portion of the peripheral wall of the conduit having a plurality of orifices such that the compartment and said portion having a plurality of orifices form an absorptive silencer.

The attenuation device may comprise two annular chambers positioned on either side of the absorptive silencer.

Such an arrangement may allow obtaining a maximum sound attenuation for a minimum of pressure losses.

The porous material may be a material which belongs to the group comprising the polymeric textiles and the metal fibers. The porous material may have a permeability comprised between 500 L/m²/s and 1600 L/m²/s.

The invention also concerns an air intake assembly of a vehicle which comprises an air intake conduit, a turbocompressor having an air inlet and an air outlet and an attenuation device.

The assembly according to the invention allows attenuating the sound emissions of the turbocompressor while reducing the pressure losses in the air intake conduit.

According to one embodiment, the attenuation device may be positioned upstream of the turbocompressor.

According to the same previous embodiment, the porous material of the attenuation device may comprise a polymeric textile.

According to another embodiment, the attenuation device may be positioned downstream of the turbocompressor.

According to the same previous embodiment, the porous material of the attenuation device may comprise metal fibers, taking into account the temperatures encountered in this configuration.

### BRIEF DESCRIPTION OF THE DRAWINGS

Other features and advantages of the invention will emerge from the following description, with reference to the appended drawings showing by way of non-limiting example an embodiment of an attenuation device according thereto.

FIG. 1 is a perspective view, in partial section, of an attenuation device according to the invention.

FIG. 2 is a front sectional view of an attenuation device according to the invention.

FIG. 3 is a front sectional view of an attenuation device comprising an absorptive silencer surrounded by two annular chambers devoid of porous material.

FIG. 4 is a comparative graph of the pressure losses relative to the air flow circulating in the device according to the invention and in known devices.

FIG. 5 is a comparative graph of the sound emissions relative to the air flow circulating in the device according to the invention and in known devices.

### DETAILED DESCRIPTION

The invention concerns an attenuation device 1 for an intake line of a thermal combustion engine equipped with a turbocompressor which is not shown in the figures.

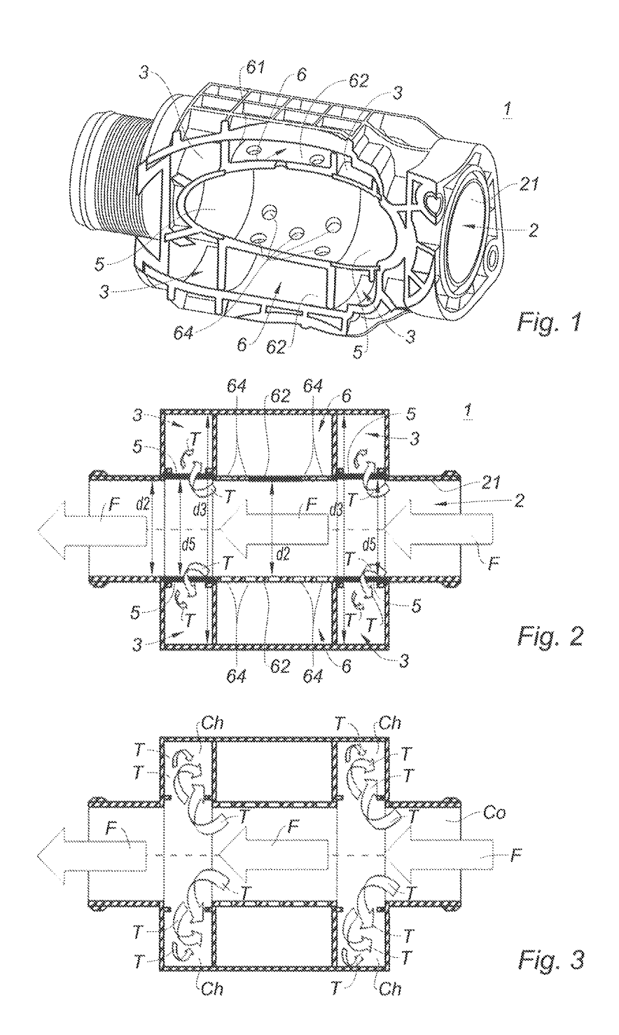

The attenuation device 1 is shown in FIGS. 1 and 2.

The attenuation device 1 may, for example, be made of polymer or metal material.

The attenuation device 1 comprises an intake gas conveying conduit 2 of a heat engine.

According to the embodiment presented here, the conduit 2 has a substantially cylindrical geometry.

The conduit 2 has an inner wall 21 with a diameter d2.

As shown in particular in FIG. 2, according to the embodiment presented here, the conduit 2 has two annular chambers 3.

Each annular chamber 3 is defined by a diameter d3 external relative to the diameter d2 of the conduit 2.

Each annular chamber 3 is obturated by a wall 5 comprising a porous material positioned in the extension of the peripheral wall 21 of the conduit 2, with a diameter d5 substantially equal to the diameter d2 of the conduit 2.

According to the embodiment presented here, the wall 5 has the geometry of a band which closes the annular chamber on its inner diameter.

According to the positioning of the attenuation device upstream or downstream of the turbocompressor and therefore according to the temperature of the air circulating in the device, the porous material may comprise a textile made of polymeric fibers or metal fibers.

The porous material may have permeability, for example, comprised between 500 L/m²/s and 1600 L/m²/s.

The positioning of the wall 5 is a particularly advantageous technical arrangement of the invention allowing trapping and dissipating a portion of the acoustic signal without generating pressure losses. This result is due in particular to the absence of a change in diameter between the conduit 2 and each annular chamber 3. The porous material wall 5 ensures a flow substantially devoid of pressure losses but which, however, participates in an acoustic attenuation.

In addition, the attenuation device 1 has a compartment 6 positioned between the two annular chambers 3.

The compartment 6 comprises an outer wall 61 positioned in the extension of the annular chambers 3, and an inner wall 62.

The inner wall 62 of the compartment 6 is formed by a portion of the peripheral wall 21 of the conduit 2. As shown, the inner wall 62 of the compartment 6 has a plurality of orifices 64. This technical arrangement allows the compartment 6 to form an absorptive silencer.

The operation of the absorptive silencer is as follows: when it is stimulated by sound waves, the small air volume contained in each orifice 64 acts substantially as a small mass which would be suspended from a spring constituted by the larger air volume contained in the compartment 6. An attenuation of the noise is accordingly obtained in a spectral band located in the vicinity of the characteristic frequency of the system «spring mass».

The invention also relates to an air intake assembly of a vehicle, which comprises an air intake conduit, a turbocompressor having an air inlet and an air outlet, and an attenuation device 1 according to the invention.

According to a first embodiment, the attenuation device 1 may be positioned upstream of the turbocompressor.

According to this first embodiment, the porous material of the attenuation device 1 comprises a polymeric textile.

According to a second embodiment, the attenuation device 1 is positioned downstream of the turbocompressor.

According to this second embodiment, the porous material of the attenuation device 1 comprises metal fibers.

FIGS. 2 and 3 allow schematically comparing the behavior of an air flow F circulating in the attenuation device according to the invention and in an attenuation device having a silencer and two annular chambers devoid of porous material.

As shown in FIG. 3, the section change between the conduit Co and each chamber Ch causes significant turbulences T when the air flow F penetrates each chamber Ch. These turbulences are the source of the pressure losses in the air flow F.

However, as shown in FIG. 2, the wall 5 comprising a porous material allows attenuating the turbulences T when the air flow F passes through the wall 5, thus minimizing the pressure losses in the air flow F.

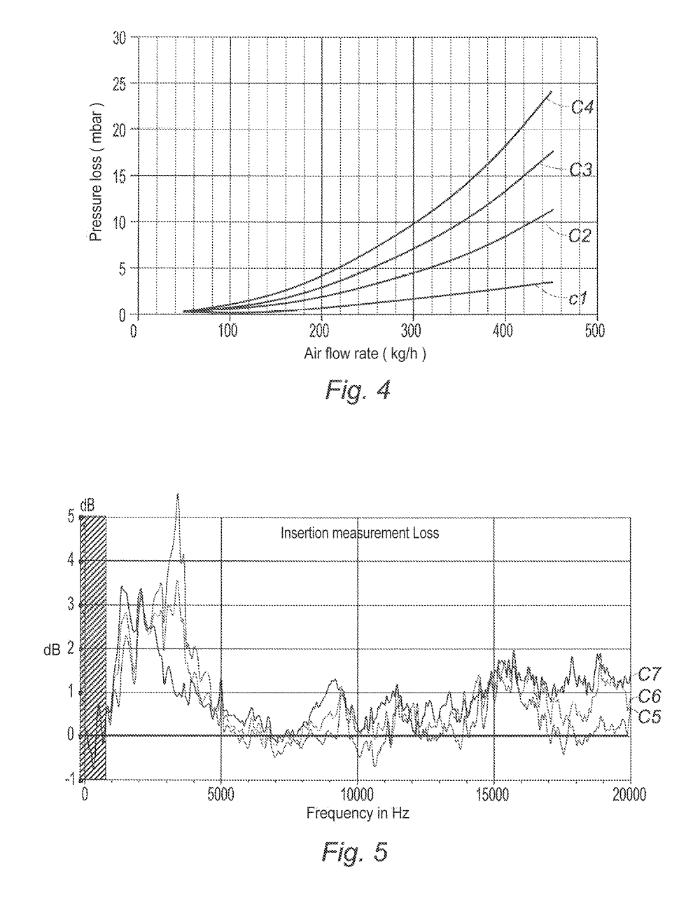

FIGS. 3 and 4 allow appreciating the performance of the acoustic attenuation device 1.

FIG. 4 is a graph showing the pressure loss as a function of the air flow circulating in different devices.

The curve C1 corresponds to an air circulation in a single tube.

The curve C2 corresponds to an air circulation in an attenuation device 1 according to the invention.

The curve C3 corresponds to an air circulation in an attenuation device having two annular chambers surrounding an absorptive silencer, only one of the two chambers is closed by a porous material.

The curve C4 corresponds to an air circulation in a device having two annular chambers, devoid of porous material, surrounding an absorptive silencer.

As shown in FIG. 4, for an air flow rate of 400 kg/h, the pressure losses in the attenuation device 1 are about 50% lower than in a device having two annular chambers, devoid of porous material, surrounding an absorptive silencer.

Thus, the attenuation device 1 allows minimizing the pressure losses relative to the devices which are the subject of the comparison.

FIG. 5 is a graph showing the level of noise emission as a function of the frequency circulating in different devices.

The curve C5 corresponds to an air circulation air in an attenuation device having two annular chambers surrounding an absorptive silencer, only one of the two chambers is closed by a porous material.

The curve C6 corresponds to an air circulation in a device having two annular chambers, devoid of porous material, surrounding an absorptive silencer.

The curve C7 corresponds to an air circulation in an attenuation device 1 according to the invention.

As shown in FIG. 5, the attenuation device 1 allows having noise absorption performances close to the performances of the devices of the prior art.

Thus, the attenuation device 1 allows optimizing the compromise between pressure loss and the noise attenuation.

The invention thus proposes a space-saving noise attenuation device which allows attenuating the noises propagated in the air intake conduits while minimizing the pressure losses.

Of course, the invention is not limited to the sole embodiment of the device described above by way of example, it encompasses on the contrary all variants.

1. An acoustic attenuation device for an intake line of a thermal combustion engine equipped with a turbocompressor, characterized in that the attenuation device comprises a gas conveying conduit having a peripheral wall and a diameter, the conduit comprising at least one radial annular chamber defined by a diameter greater than the diameter of the conduit, the or each annular chamber being closed by a wall comprising a porous material, positioned in the extension of the peripheral wall of the conduit, according to a diameter substantially equal to the diameter of the conduit, in order to allow an air circulation between the conduit and the or each peripheral chamber.

2. The acoustic attenuation device according to claim 1, characterized in that the attenuation device has a compartment which comprises an outer wall and an inner wall formed by a portion of the peripheral wall of the conduit, the portion of the peripheral wall of the conduit having a plurality of orifices such that the compartment and said portion having a plurality of orifices form an absorptive silencer.

3. The acoustic attenuation device according to claim 2, characterized in that the attenuation device comprises two annular chambers positioned on either side of the absorptive silencer.

4. The acoustic attenuation device according to claim 1, characterized in that the porous material is a material comprising polymeric textiles.

5. The acoustic attenuation device according to claim 1, characterized in that the porous material is a material comprising metal fibers.

6. The acoustic attenuation device according to claim 1, characterized in that the porous material has a permeability comprised between 500 L/m²/s and 1600 L/m²/s.

7. An air intake assembly of a vehicle characterized in that it comprises an air intake conduit, a turbocompressor having an air inlet and an air outlet and an attenuation device according to claim 1.

8. An intake assembly according to claim 7, characterized in that the attenuation device is positioned upstream of the turbocompressor.

9. The intake assembly according to claim 8, characterized in that the porous material of the attenuation device comprises a polymeric textile.

10. The intake assembly according to claim 7, characterized in that the attenuation device is positioned downstream of the turbocompressor.

11. The intake assembly according to claim 10, characterized in that the porous material of the attenuation device comprises metal fibers.

12. The acoustic attenuation device according to claim 2, characterized in that the porous material is a material comprising polymeric textiles.

13. The acoustic attenuation device according to claim 3, characterized in that the porous material is a material comprising polymeric textiles.

14. The acoustic attenuation device according to claim 2, characterized in that the porous material is a material comprising metal fibers.

15. The acoustic attenuation device according to claim 3, characterized in that the porous material is a material comprising metal fibers.

16. The acoustic attenuation device according to claim 2, characterized in that the porous material has a permeability comprised between 500 L/m²/s and 1600 L/m²/s.

17. The acoustic attenuation device according to claim 3, characterized in that the porous material has a permeability comprised between 500 L/m²/s and 1600 L/m²/s.

18. The acoustic attenuation device according to claim 4, characterized in that the porous material has a permeability comprised between 500 L/m²/s and 1600 L/m²/s.

19. The acoustic attenuation device according to claim 5, characterized in that the porous material has a permeability comprised between 500 L/m²/s and 1600 L/m²/s.

20. The acoustic attenuation device according to claim 12, characterized in that the porous material has a permeability comprised between 500 L/m²/s and 1600 L/m²/s.
